(19) United States
(12) Patent Application Publication
(10) Pub. No.: US 2011/0218287 A1
(43) Pub. Date: Sep. 8, 2011

(54) Coatings for electronic circuits

(75) Inventors: Mario Brockschmidt, Essen (DE); Sabrina Buckl, Erlangen (DE); Peter Gröppel, Erlangen (DE); Markus Richter, Burglengenfeld (DE); Michael Schweizer, Ulm (DE)

(73) Assignee: Siemens Aktiengesellschaft, München (DE)

(21) Appl. No.: 12/998,207

(22) PCT Filed: Sep. 2, 2009
(86) PCT No.: PCT/EP2009/061305

§ 371 Date: May 16, 2011

(30) Foreign Application Priority Data
Sep. 25, 2008 (DE) 102008048874.7

(51) Int. Cl. C08K 3/22; C08K 3/20; C08K 3/34; B82Y 30/00

(52) U.S. Cl. 524/430; 524/401; 524/437; 524/493; 524/497; 977/773; 977/811; 977/932

(57) ABSTRACT

Printed circuit boards are coated with nanoparticulate inorganic oxides. The coatings have increased partial discharge resistance.

### CROSS REFERENCE TO RELATED APPLICATIONS

This application is the U.S. national stage of International Application No. PCT/EP2009/061305, filed Sep. 2, 2009 and claims the benefit thereof. The International Application claims the benefits of German Application No. 102008048874.7 filed on Sep. 25, 2008, both applications are incorporated by reference herein in their entirety.

### BACKGROUND

Modern electronic circuits need to satisfy special, ever-growing demands. The constructional requirements for high circuit density, synonymous with closely adjacent electronic components and conductor paths in close proximity, are to be derived from the necessity to accommodate ever more electronics in a complex system.

The smaller the design of electronic circuits is, however, the greater becomes the danger of failures in the insulation and protection systems as a result for example of stress due to changes in temperature, surge currents, leakage currents and breakdowns. External partial discharges (corona discharges) and the occurrence of treeing phenomena as a result of internal partial discharges can scarcely be detected visually but can lead to the erosion of material and ultimately to a breakdown or flashover between two electrical conductors at different potentials.

### SUMMARY

Described below are coatings for electronic circuits, with which the aforementioned disadvantages can at least in part be overcome and with which in particular an increased resistance to partial discharge can be achieved. Accordingly, a resin-based protective lacquer coating for printed circuit boards of electronic circuits is proposed, containing at least one nanoparticulate inorganic oxide.

In this situation, the designation “protective lacquer coating” comprises and/or signifies in particular a layer of material which is applied in order to protect a surface. Nonrestrictive examples of protective lacquer coatings are in particular those coatings which protect substrates against environmental influences, for example: corrosion of solder connections, humidity, mold, fuels and process solvents, operating temperatures as well as dust, contamination and physical damage during handling.

The designation “resin-based” here comprises and/or signifies in particular that the protective lacquer coating is composed the most part or to a substantial degree of an organic material which exhibits a high viscosity. Examples of resins that may be used in this situation are epoxy resins, polyurethane resins, aminoplasts, ABS plastics.

The designation “nanoparticulate” here comprises and/or signifies in particular an essentially spherical composition, whereby the average diameter of the spheres lies below 100 nm.

The designation “inorganic oxide” here comprises and/or signifies in particular all the solid oxide, oxide-hydroxide, oxide-nitride compounds of non-carbon compounds.

It has surprisingly become apparent that such a protective lacquer coating exhibits a drastically increased resistance to partial discharge with regard to most applications, which means that the problems mentioned in the introduction can frequently be drastically reduced or even eliminated entirely.

Furthermore, it has been possible with regard to most applications to reveal or achieve at least one of the following advantages:

a greatly improved resistance to scratching

barrier effects against gases, water vapor and solvents

increased resistance to weathering and slowed thermal ageing

reduction in the curing shrinkage and heat of reaction

reduced thermal expansion and internal stress

increase in the tensile strength, fracture toughness and modulus of elasticity

improved adhesion on numerous inorganic and organic substrates

Reduced fire load

No volatile organic compounds

User friendliness, as a one-component system

According to an embodiment, the nanoparticulate oxide has on average a particle diameter of ≧5 and ≦100 nm.

This has proved to be advantageous for most applications. The nanoparticulate oxide may have on average a particle diameter of ≧10 and ≦60 nm, particularly ≧15 and ≦40 nm.

According to an embodiment, the variation of the diameters of the at least one nanoparticulate oxide has a half width a of ≦20 nm. This has proved itself especially in practice because the resistance to partial discharge can thus often be further increased.

The variation of the diameters of the at least one nanoparticulate oxide may have a half width σ of ≦10 nm, particularly ≦8 nm, more particularly ≦5 nm, and still more particularly ≦3 nm.

According to an embodiment, whereby the nanoparticulate oxide contains a material, selected from the group containing Al₂O₃, AlOOH, SiO₂, TiO₂, GeO₂, layered silicates and organically modified layered silicates, BN, Al3N4, and mixtures thereof.

According to an embodiment, the at least one nanoparticulate inorganic oxide is dispersed in the coating.

This has proved to be advantageous because a curing by using UV (in order to produce an epoxy resin for example) is thus for the most part possible without any problems.

According to an embodiment, the proportion of the nanoparticulate oxide in the protective lacquer coating (weight/weight) ranges from ≧5% to ≦60%. This has proved itself especially in practice because the advantageous properties can thus often be achieved particularly well whilst simultaneously retaining the coating's good handling qualities.

The proportion of the nanoparticulate inorganic oxide in the protective lacquer coating (weight/weight) may be from ≧10% to ≦50%, particularly ≧15% to ≦40%.

The aforementioned components, as well as those claimed and described in the exemplary embodiments, are not subject to any special exceptional conditions in regard to their size, shape, material selection and technical design, so that the known selection criteria in the field of application can be applied without restrictions.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a representation of a Toepler gliding arrangement of a protective lacquer coating; and

FIG. 2 is a representation of a Toepler gliding arrangement of a protective lacquer coating according to the prior art.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

### Example I

A purely illustrative Example I follows, which represents a protective lacquer coating in accordance with a first embodiment.

In this coating, SiO₂ particles having a particle size of approx. 20 nm (half width approx. 10 nm) were dispersed in an epoxy resin (bisphenol A diglycidyl ether). The percent by weight of the SiO₂ particles in the resin amounted to approx. 40%.

A resin without nanoparticles was chosen as an example for comparison purposes.

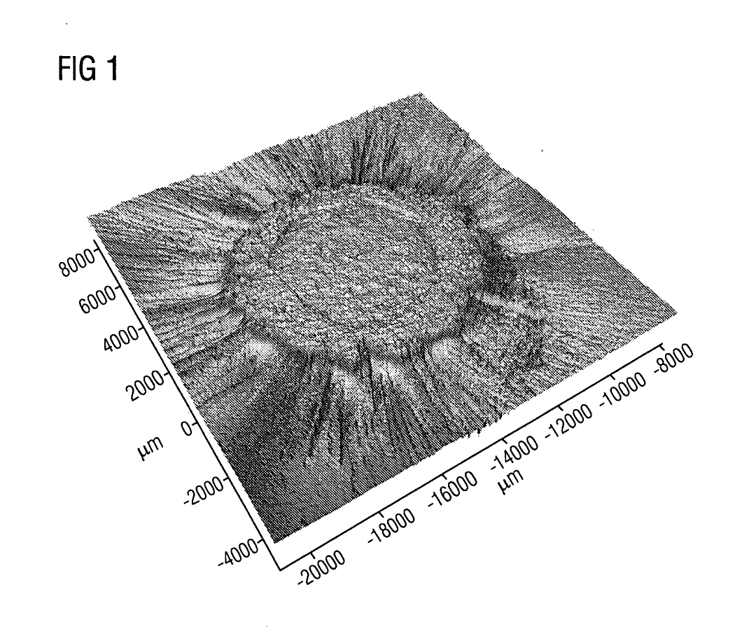

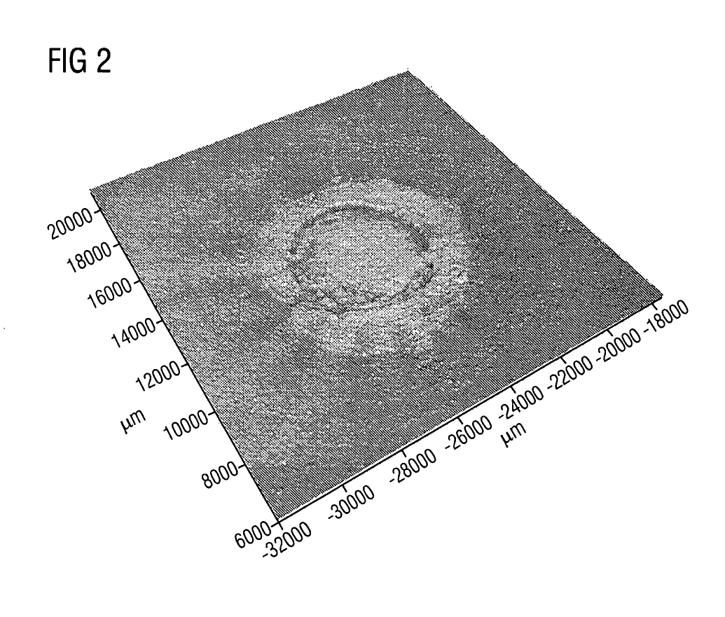

FIGS. 1 and 2 show the resistance to partial discharge of the coatings with the aid of a Toepler gliding arrangement. In said arrangement the coatings have been applied to a copper electrode contacted to ground. A cylindrical electrode having a 1 mm radius cross-section has been mounted on the coatings, whereby at a constant voltage locally limited external partial discharges are produced in the spandrel, which result in an erosion of the material.

FIGS. 1 and 2 show the coatings after 240 hours of ageing at an electrical field strength of 13 kV/mm. In this situation, for the sample filled with nanoparticulate this resulted in an eroded total volume of 1.69 mm² and a maximum depth of erosion of 34 μm, whereas for the unfilled sample a maximum depth of erosion of 194 μm and an erosion volume of 7 mm² resulted.

### Example II

In a further example, a further coating was produced and was investigated with the aid of a Toepler gliding arrangement. In this coating, Al₂O₃ particles having a particle size of approx. 40 nm (half width approx. 20 nm) were dispersed in an epoxy resin (bisphenol A diglycidyl ether). The percent by weight of the particles in the resin amounted to approx. 20%.

In this situation, for the sample filled with nanoparticulate this resulted in an eroded total volume of 2.30 mm² and a maximum of erosion of 50 μm.

### Example II

In a further example, a further coating was produced and was investigated with the aid of a Toepler gliding arrangement. In this coating, TiO₂ particles having a particle size of approx. 35 nm (half width approx. 20 nm) were dispersed in an epoxy resin (bisphenol A diglycidyl ether). The percent by weight of the TiO₂ particles in the resin amounted to approx. 15%.

In this situation, for the sample filled with nanoparticulate this resulted in an eroded total volume of 2.85 mm² and a maximum depth of erosion of 55 μm.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-6. (canceled)

7. A resin-based protective lacquer coating for printed circuit boards of electronic circuits, comprising
at least one nanoparticulate inorganic oxide.

8. The coating as claimed in claim 7, wherein the at least one nanoparticulate oxide has on average a particle diameter ≧10 nm and ≦90 nm.

9. The coating as claimed in claim 8, wherein the at least one nanoparticulate oxide has diameters varying by a half width σ of ≦10 nm.

10. The coating as claimed in claim 9, wherein the nanoparticulate oxide comprises a material selected from the group consisting of Al₂O₃, AlOOH, SiO₂, TiO₂, GeO₂ and mixtures thereof.

11. The coating as claimed in claim 10, wherein the at least one nanoparticulate inorganic oxide is dispersed in the coating.

12. The coating as claimed in claim 11, wherein a weight/weight proportion of the nanoparticulate inorganic oxide in the protective lacquer coating is ≧5% and ≦60%.

13. The coating as claimed in claim 9, wherein the at least one nanoparticulate inorganic oxide is dispersed in the coating.

14. The coating as claimed in claim 13, wherein a weight/weight proportion of the nanoparticulate inorganic oxide in the protective lacquer coating is ≧5% and ≦60%.

15. The coating as claimed in claim 9, wherein a weight/weight proportion of the nanoparticulate inorganic oxide in the protective lacquer coating is a ≧5% and ≦60%.

16. The coating as claimed in claim 8, wherein the nanoparticulate oxide comprises a material selected from the group consisting of Al₂O₃, AlOOH, SiO₂, TiO₂, GeO₂ and mixtures thereof.

17. The coating as claimed in claim 16, wherein the at least one nanoparticulate inorganic oxide is dispersed in the coating.

18. The coating as claimed in claim 17, wherein a weight/weight proportion of the nanoparticulate inorganic oxide in the protective lacquer coating is ≧5% and ≦60%.

19. The coating as claimed in claim 8, wherein the at least one nanoparticulate inorganic oxide is dispersed in the coating.

20. The coating as claimed in claim 19, wherein a weight/weight proportion of the nanoparticulate inorganic oxide in the protective lacquer coating is ≧5% and ≦60%.

21. The coating as claimed in claim 8, wherein a weight/weight proportion of the nanoparticulate inorganic oxide in the protective lacquer coating is ≧5% and ≦60%.

22. The coating as claimed in claim 7, wherein the at least one nanoparticulate oxide has diameters varying by a half width σ of ≦10 nm.

23. The coating as claimed in claim 7, wherein the nanoparticulate oxide comprises a material selected from the group consisting of Al₂O₃, AlOOH, SiO₂, TiO₂, GeO₂ and mixtures thereof.

24. The coating as claimed in claim 7, wherein the at least one nanoparticulate inorganic oxide is dispersed in the coating.

25. The coating as claimed in claim 7, wherein a weight/weight proportion of the nanoparticulate inorganic oxide in the protective lacquer coating is ≧5% and ≦60%.
